(19) United States
(12) Patent Application Publication
(10) Pub. No.: US 2026/0134167 A1
(43) Pub. Date: May 14, 2026

(54) Reliability Optimization Method for Ultra-deep Water Pile Hammer System

(71) Applicants: RELIABILITY OPTIMIZATION METHOD OF ULTRA-DEEP WATER PILING HAMMER SYSTEM, Shandong (CN); CHINA SHIYOU UNIVERSITY (EAST CHINA), Shandong (CN)

(72) Inventors: Hongyan Wang, Shandong (CN); Wensheng Xiao, Shandong (CN); Wentai Yu, Shandong (CN); Liping Tan, Shandong (CN); Teng Wang, Shandong (CN); Shunqing Liu, Shandong (CN); Jianghao Li, Shandong (CN); Jiaxiang Zhang, Shandong (CN); Ziwei Zheng, Shandong (CN); Youfu Sun, Shandong (CN)

(21) Appl. No.: 19/118,067

(22) PCT Filed: Dec. 12, 2024
(86) PCT No.: PCT/CN2024/138654

§ 371 Date: Apr. 3, 2025

(30) Foreign Application Priority Data
Dec. 14, 2023 (CN) 202311714328.5

(51) Int. Cl. G06F 30/20; G06F 30/17; G06F 111/10; G06F 119/02

(52) U.S. Cl. CPC G06F 30/20; G06F 30/17; G06F 2111/10; G06F 2119/02

(57) ABSTRACT

Provided is a reliability optimization method for an ultra-deep water pile hammer system. The reliability optimization method is intended to perform reliability analysis on a pile hammer system and includes: performing function analysis and functional module division on a mechanical system, a power system, a hydraulic system, a pneumatic system, and an electronic control system of the ultra-deep water pile hammer system, regarding the five systems as five first-level subsystems, defining key parameters of the first-level subsystems, and further dividing the first-level subsystems into second-level subsystems; performing hazard degree analysis on the second-level subsystems; allocating first-level subsystem, second-level subsystem, and second-level subsystem failure mode reliability indices of an ultra-deep water pile hammer, and obtaining an optimal reliability allocation solution of the ultra-deep water pile hammer system. The parameters of the first-level systems and the second-level systems are combined and failure modes are considered to obtain the optimal reliability allocation solution.

This patent application claims the benefit and priority of Chinese Patent Application No. 202311714328.5 filed with the China National Intellectual Property Administration on Dec. 14, 2023, and entitled “RELIABILITY OPTIMIZATION METHOD FOR ULTRA-DEEP WATER PILE HAMMER SYSTEM”, the disclosure of which is incorporated by reference herein in its entirety as part of the present application.

### TECHNICAL FIELD

The present disclosure provides a reliability optimization method for an ultra-deep water pile hammer system, which belongs to the technical field of design of machine parameters or variables in electro-digital data processing.

### BACKGROUND

An ultra-deep water pile hammer system operates in high-pressure high-corrosion severe marine environment for a long time. Tremendous counter-acting force produced in the deep-sea piling operation requires extremely high reliability. However, global reliability studies on ultra-deep water pile hammer systems are staying at a one-sided level, such as quick-wear parts or hydraulic control system, and there is no systematic study yet. Besides, research on key technologies such as product design, manufacturing process, and control system is relatively lagging in China, and there is also no referential successful experience. Given the various shortcomings in China's research on the ultra-deep water pile hammer system, in order to realize the localization of the system and ensure their high reliability for deep-sea operation, it is necessary to conduct reliability research on the ultra-deep water pile hammer system.

### SUMMARY

An objective of the present disclosure is to provide a reliability optimization method for an ultra-deep water pile hammer system to solve the problem of difficult pile hammer system reliability analysis in the prior art.

A reliability optimization method for an ultra-deep water pile hammer system includes:
S1, performing function analysis and functional module division on a mechanical system, a power system, a hydraulic system, a pneumatic system, and an electronic control system of the ultra-deep water pile hammer system, regarding the five systems as five first-level subsystems, and defining key parameters of the first-level subsystems;
where the key parameters of the first-level subsystems include design requirements of a complexity degree, an importance degree, and a reliability degree, a failure mode and a severity degree of influence on the ultra-deep water pile hammer system, and a series-parallel connection relationship between the first-level subsystems;
S2, further dividing the first-level subsystems into second-level subsystems, the second-level subsystems being parts or components constituting the first-level subsystems; and defining key parameters of the second-level subsystems;
where the key parameters of the second-level subsystems include design requirements of a complexity degree, an importance degree, and a reliability degree, a hazard degree under a certain severe degree, an occurrence probability and a hazard degree of a certain failure mode, and a series-parallel connection relationship between the second-level subsystems;
S3, performing hazard degree analysis on the second-level subsystems;
S4, establishing a first-level subsystem reliability allocation model to allocate a first-level subsystem reliability index of an ultra-deep water pile hammer;
S5, establishing a second-level subsystem reliability allocation model to allocate second-level subsystem reliability indices of the ultra-deep water pile hammer;
S6, establishing a second-level subsystem failure mode reliability allocation model to allocate second-level subsystem failure mode reliability indices of the ultra-deep water pile hammer; and
S7, obtaining an optimal reliability allocation solution of the ultra-deep water pile hammer system.

S3 includes performing hazard degree analysis on the second-level subsystems by an improved quantitative hazard analysis method, and a calculation formula for a hazard degree Cₚ of a part is as follows:

$${C}_{p} = {Σ}_{i = 1}^{k} {λ}_{p} {α}_{i} {β}_{i} {s}_{i} t ;$$

where Cₚ represents the hazard degree of the part; k represents a total number of failure modes of the part; λₚ represents an occurrence rate of an ith failure mode of the part; αᵢ represents a percentage of the occurrence rate of the ith failure mode and a sum of occurrence rates of all the failure modes of the part; 8, represents a conditional probability of the ith failure mode of the part causing a system failure, 0≤_{βi}≤1; sᵢ represents a severe degree of the ith failure mode of the part; and t represents an average operation time of the part.

S4 includes using an improved Advisory Group on Reliability of Electronic Equipment (AGREE) reliability allocation method to allocate the first-level subsystem reliability indices of the ultra-deep water pile hammer:

$${( {W}_{j}^{*} )}^{2} = \frac{{Σ}_{v = 1}^{m} {Σ}_{i = 1}^{k} {λ}_{p} {α}_{i} {β}_{i} {s}_{i} t}{{Σ}_{v = 1}^{n} {Σ}_{i = 1}^{k} {λ}_{p} {α}_{i} {β}_{i} {s}_{i} t} = \frac{{Σ}_{v = 1}^{m} {c}_{pv}}{{Σ}_{v = 1}^{n} {c}_{pv}} = \frac{{θ}_{j}}{θ} ;$$

where

$${W}_{j}^{*}$$

represents a correction importance of a jth subsystem; m represents a number of parts of the jth subsystem; k represents a number of failure modes of a vth part; n represents a number of parts of the whole system; Cₚᵥ represents a hazard degree of the vth part; θⱼ represents a hazard degree of the jth subsystem; and θ represents a hazard degree of the whole system.

S5 includes using a reliability allocation method based on Failure Mode, Effects and Hazard degree Analysis (FMECA) to allocate the second-level subsystem reliability indices of the ultra-deep water pile hammer:

$$\{ \begin{matrix}{P}_{jv} = {P}_{j} \frac{1}{{ω}_{jv}} / {\sum }_{v = 1}^{m} \frac{1}{{ω}_{jv}} \\ {ω}_{j} = ( \frac{{C}_{p 1}}{{Σ}_{v = 1}^{m} {C}_{pv}} , … , \frac{{C}_{pv}}{{Σ}_{v = 1}^{m} {C}_{pv}} , … , \frac{{C}_{pm}}{{Σ}_{v = 1}^{m} {C}_{pv}} )\end{matrix} ;$$

where Pⱼᵥ represents a reliability index of the vth part of the jth subsystem; Pⱼ represents a specified reliability allocation index of the jth subsystem; ωⱼ represents a normalized weight of the parts of the jth subsystem relative to the subsystem; ωⱼᵥ represents a normalized weight of the vth part of the jth subsystem relative to the subsystem; and Cₚₘ represents a hazard degree of an mth part.

S6 includes using a predicted value based allocation method to perform reliability allocation on basic failure modes of a part; the basic failure modes of the part are all in a series connection relationship, and the reliability allocation is performed on the part only when a specified failure probability is lower than a predicted failure probability, with a reliability degree allocation formula being as follows:

$$\{ \begin{matrix}{q}_{ip} = {q}_{iy} \frac{{q}_{sq}}{{q}_{sy}} \\ {R}_{ip} = 1 - {q}_{ip}\end{matrix} i ∈ [ 1 , n ] ;$$

where qᵢₚ represents an unreliability allocation value of an ith failure mode; q_{iy} represents a predicted occurrence rate value of the ith failure mode; q_{sq} represents a specified failure rate value for the part; q_{sy} represents a predicted failure rate value for the part; Rip represents a reliability degree allocation value of the ith failure mode; and qᵢₚ represents an unreliability allocation value of an ith failure mode.

S7 includes comparing a second-level subsystem hazard degree analysis result, a first-level subsystem reliability index allocation result, a second-level subsystem reliability index allocation result, and a second-level subsystem failure mode reliability index allocation result, and selecting an optimal value, to form the optimal reliability allocation solution.

Compared with the prior art, the present disclosure has the following beneficial effects: the parameters of the first-level systems and the second-level systems are combined and failure modes are considered to obtain the optimal reliability allocation solution.

### DETAILED DESCRIPTION OF THE EMBODIMENTS

In order to make the objective, technical solutions, and advantages of the embodiments of the present disclosure clearer, the technical solutions in the present disclosure are described clearly and completely below. Apparently, the described embodiments are some rather than all of the embodiments of the present disclosure. All other embodiments derived from the embodiments of the present disclosure by a person of ordinary skill in the art without creative efforts shall fall within the protection scope of the present disclosure.

A reliability optimization method for an ultra-deep water pile hammer system includes the following steps.

S1, function analysis and functional module division are performed on a mechanical system, a power system, a hydraulic system, a pneumatic system, and an electronic control system of the ultra-deep water pile hammer system; the five systems are regarded as five first-level subsystems; and important indices of the first-level subsystems are defined.

The key parameters of the first-level subsystems include design requirements of a complexity degree, an importance degree, and a reliability degree, a failure mode and a severity degree of influence on the ultra-deep water pile hammer system, and a series-parallel connection relationship between the first-level subsystems.

S2, the first-level subsystems are further divided into second-level subsystems, the second-level subsystems being parts or components constituting the first-level subsystems; and key parameters of the second-level subsystems are defined.

The key parameters of the second-level subsystems include design requirements of a complexity degree, an importance degree, and a reliability degree, a hazard degree under a certain severe degree, an occurrence probability and a hazard degree of a certain failure mode, and a series-parallel connection relationship between the second-level subsystems.

S3, hazard degree analysis is performed on the second-level subsystems.

S4, a first-level subsystem reliability allocation model is established to allocate first-level subsystem reliability indices of an ultra-deep water pile hammer.

S5, a second-level subsystem reliability allocation model is established to allocate second-level subsystem reliability indices of the ultra-deep water pile hammer;

S6, a second-level subsystem failure mode reliability allocation model is established to allocate second-level subsystem failure mode reliability indices of the ultra-deep water pile hammer.

S7, an optimal reliability allocation solution of the ultra-deep water pile hammer system is obtained.

S3 includes using an improved quantitative hazard degree analysis method to perform hazard degree analysis on the second-level subsystems, and a calculation formula for a hazard degree Cₚ of a part is as follows:

$${C}_{p} = {Σ}_{i = 1}^{k} {λ}_{p} {α}_{i} {β}_{i} {s}_{i} t ;$$

where Cₚ represents the hazard degree of the part; k represents a total number of failure modes of the part; λₚ represents an occurrence rate of an ith failure mode of the part; αᵢ represents a percentage of the occurrence rate of the ith failure mode of the part in a sum of occurrence rates of all the failure modes of the part; βᵢ represents a conditional probability of the ith failure mode of the part causing a system failure, 0≤βᵢ≤1; sᵢ represents a severe degree of the ith failure mode of the part; and/represents an average operation time of the part.

S4 includes using an improved Advisory Group on Reliability of Electronic Equipment (AGREE) reliability allocation method to allocate the first-level subsystem reliability indices of the ultra-deep water pile hammer:

$${( {W}_{j}^{*} )}^{2} = \frac{{Σ}_{v = 1}^{m} {Σ}_{i = 1}^{k} {λ}_{p} {α}_{i} {β}_{i} {s}_{i} t}{{Σ}_{v = 1}^{n} {Σ}_{i = 1}^{k} {λ}_{p} {α}_{i} {β}_{i} {s}_{i} t} = \frac{{Σ}_{v = 1}^{m} {C}_{pv}}{{Σ}_{v = 1}^{n} {C}_{pv}} = \frac{{θ}_{j}}{θ} ;$$

where

$${W}_{j}^{*}$$

represents a correction importance degree of a jth subsystem; m represents a number of parts of the jth subsystem; k represents a number of failure modes of a vth part; n represents a number of parts of the whole system; Cₚᵥ represents a hazard degree of the vth part; θⱼ represents a hazard degree of the jth subsystem; and θ represents a hazard degree of the whole system.

S5 includes using a reliability allocation method based on Failure Mode, Effects and Hazard degree Analysis (FMECA) to allocate the second-level subsystem reliability indices of the ultra-deep water pile hammer:

$$\{ \begin{matrix}{P}_{jv} = {P}_{j} \frac{1}{{ω}_{jv}} / {\sum }_{v = 1}^{m} \frac{1}{{ω}_{jv}} \\ {ω}_{j} = ( \frac{{C}_{p 1}}{{Σ}_{v = 1}^{m} {C}_{pv}} , … , \frac{{C}_{pv}}{{Σ}_{v = 1}^{m} {C}_{pv}} , … , \frac{{C}_{pm}}{{Σ}_{v = 1}^{m} {C}_{pv}} )\end{matrix} ;$$

where Pⱼᵥ represents a reliability index of the vth part of the jth subsystem; Pⱼ represents a specified reliability allocation index of the jth subsystem; ωⱼ represents a normalized weight of the parts of the jth subsystem relative to the subsystem; ωⱼᵥ represents a normalized weight of the vth part of the jth subsystem relative to the subsystem; and Cₚₘ represents a hazard degree of an mth part.

S6 includes using a predicted value based allocation method to perform reliability allocation on basic failure modes of a part; the basic failure modes of the part are all in a series connection relationship, and the reliability allocation is performed on the part only when a specified failure probability is lower than a predicted failure probability, with a reliability degree allocation formula being as follows:

$$\{ \begin{matrix}{q}_{ip} = {q}_{iy} \frac{{q}_{sq}}{{q}_{sy}} \\ {R}_{ip} = 1 - {q}_{ip}\end{matrix} i ∈ [ 1 , n ] ;$$

where qᵢₚ represents an unreliability allocation value of an ith failure mode; q_{iy} represents a predicted occurrence rate value of the ith failure mode; q_{sq} represents a specified failure rate value for the part; q_{sy} represents a predicted failure rate value for the part; Rip represents a reliability degree allocation value of the ith failure mode; and qᵢₚ represents an unreliability allocation value of an ith failure mode.

S7 includes comparing a second-level subsystem hazard degree analysis result, a first-level subsystem reliability index allocation result, a second-level subsystem reliability index allocation result, and a second-level subsystem failure mode reliability index allocation result, and selecting an optimal value, to form the optimal reliability allocation solution.

In an embodiment, when hazard degree analysis is performed on the second-level subsystems, common hazard degree analysis methods include a qualitative hazard degree matrix diagram method, a quantitative hazard degree matrix diagram method, a risk priority number method, a cost priority number method, a fuzzy risk priority number method, etc. These methods have their own characteristics and scopes of application and need to be adjusted and improved when they are applied to perform failure hazard degree analysis on parts of a pile hammer. The traditional quantitative hazard degree analysis is directed against a failure mode hazard degree Cₘ and a product hazard degree Cᵣ:

$${C}_{r} = {Σ}_{i = 1}^{n} {C}_{mi} = {Σ}_{i = 1}^{n} {λ}_{p} {α}_{i} {β}_{i} t ;$$

where n represents a total number of failure modes under a certain severe degree; Cᵣ represents a hazard degree of a part under the certain severe degree; Cₘᵢ represents a hazard degree of an ith failure mode of the part; λₚ represents an occurrence rate of the ith failure mode of the part, 10⁻⁶·h⁻¹; αᵢ represents a percentage of the occurrence rate of the ith failure mode a sum of occurrence rates of all the failure modes of the part; βᵢ represents a conditional probability of the ith failure mode of the part causing a system failure, 0≤βᵢ≤1, and assuming that the occurrence of a failure mode of any part will cause a system failure, a value of βᵢ is 1; and t represents an average operation time of the part, h.

What is finally obtained by the traditional hazard degree analysis is a hazard degree of a part at a specified severe degree level. With this analysis result, the hazard degree of the part cannot be assessed comprehensively, and the analysis result has no guiding significance for the reliability research on the part. In order to solve the problem, a severe degree of a failure mode of a part is introduced into analysis, and the improved quantitative hazard degree analysis method is proposed. An analysis object of the improved quantitative hazard degree analysis method is changed from a hazard degree of a part under a certain severe degree to the hazard degree of the part such that prevention is focused on a part with a great hazard degree and an improvement measure is proposed, thereby improving the safety performance of the whole system.

In combination with the reliability data of a part of the ultra-deep water pile hammer system and a failure mode (for occurrence rates of failure modes of some parts, reference may be made to general reliability data), taking the mechanical system of the ultra-deep water pile hammer as an example, the hazard degree of a part of the mechanical system is ascertained, as shown in Table 1.

TABLE 1
Parts Hazard Degree of Mechanical System

| | | λₚ/ | | | | |
|---|---|---|---|---|---|---|
| Part | Failure Mode | (10⁻⁶ · h⁻¹) | αᵢ | Sᵢ | t/h | Cₚ |
| Hammer | The joint of the hammer | 5.7 | 19.96% | 5 | 43800 | 1.199456633 |
| head | head and hammer core | | | | | |
| (hammer | becomes loose. | | | | | |
| core) | The hammer cannot be | 5.77 | 20.21% | 4 | | |
| | lowered | | | | | |
| | The hammer head crack. | 5.68 | 19.89% | 5 | | |
| | The hammer core fracture. | 5.68 | 19.89% | 5 | | |
| | The hammer head off | 5.72 | 20.04% | 5 | | |
| | cylinder. | | | | | |
| Anvil | Cracking | 5.72 | 44.90% | 5 | 43800 | 1.035610776 |
| | Serious corrosion | 1.3 | 10.20% | 4 | | |
| | Fatigue failure | 5.72 | 44.90% | 4 | | |
| Pile | The pile body fracture. | 4.68 | 30.51% | 5 | 525600 | 10.737918915 |
| | Pile top fragmentation | 4.68 | 30.51% | 5 | | |
| | Insufficient sinking | 1.3 | 8.47% | 4 | | |
| | The pile body tilts. | 4.68 | 30.51% | 4 | | |
| Pile cap | Fatigue failure | 0.95 | 50.00% | 4 | 43800 | 0.166440000 |
| | Shattering | 0.95 | 50.00% | 4 | | |
| Hammer | Falls off. | 5.72 | 35.48% | 5 | 17520 | 0.450817858 |
| core | The connection with the | 5.72 | 35.48% | 5 | | |
| hanging | hammer core is broken. | | | | | |
| unit | Deformed. | 4.68 | 29.03% | 4 | | |
| Shock | Fatigue failure. | 1.3 | 50.00% | 4 | 8760 | 0.045552000 |
| absorbing | Sufficient in pressure and | 1.3 | 50.00% | 4 | | |
| ring | unable to absorb shock. | | | | | |

In Table 1, Sᵢ and Cₚ are indices that are assessed according to values and are unitless. They are assessed and determined according to values.

When the first-level subsystem reliability indices of the ultra-deep water pile hammer are allocated, the AGREE allocation method is as follows:

$${R}_{i} ( t ) = 1 - \frac{1 - {[ {R}_{S} ( t ) ]}^{{C}_{i}}}{{W}_{i}} ;$$

where Cᵢ represents a complexity degree of an ith subsystem; Wᵢ represents an importance degree of the ith subsystem; Rₛ(t) represents a reliability design index of the system; and Rᵢ(t) represents a reliability degree of the ith subsystem after allocation.

The importance degree Wᵢ and the complexity degree Cᵢ of the ith subsystem are defined as:

$$\{ \begin{matrix}{W}_{i} = \frac{{N}_{i}}{{r}_{i}} \\ {C}_{i} = \frac{{n}_{i}}{{Σ}_{i = 1}^{k} {n}_{i}} = \frac{{n}_{i}}{N}\end{matrix} ;$$

where Nᵢ represents a number of times that an upper-level system is out of order due to failures of the ith subsystem; rᵢ represents a number of times that the ith subsystem is out of order; nᵢ represents a number of major parts of the ith subsystem; and N represents a number of major parts of the whole system.

In the traditional AGREE reliability allocation method, an importance degree of a subsystem is defined is defined as a ratio of a number of times that the system is out of order caused by failures of the subsystem to a number of times that the subsystem is out of order. Therefore, the importance degrees of the subsystems are all 1, which is meaningless for comparison. In a practical project, multiple factors such as a failure rate, a failure risk degree, and an average operation time need to be taken into account for the importance degree of the subsystem. To make the allocation result of the AGREE method more referential, the importance degree of the subsystem is corrected based on the hazard degree analysis on parts, and an improved AGREE reliability allocation method is proposed.

The improved AGREE reliability allocation method is to allocate reliability design indices preliminarily designed for the system to the subsystems. The improved AGREE reliability allocation method is to perform reliability allocation on the system and perform contrastive analysis. The basic parameters of the AGREE allocation method are as shown in Table 2.

TABLE 2
Parameter Table of AGREE Allocation Method

| | | | | Traditional | Correction |
|---|---|---|---|---|---|
| | Number | | Hazard | Importance | importance |
| Subsystem | of Parts | Complexity | degree | Degree | Degree |
| Hydraulic | 7 | 0.2333 | 1.21185580 | 1 | 0.26889485 |
| system | | | | | |
| Pneumatic | 5 | 0.1667 | 0.14166143 | 1 | 0.09193541 |
| system | | | | | |
| Electronic | 7 | 0.2333 | 1.21774768 | 1 | 0.26954773 |
| control | | | | | |
| system | | | | | |
| Mechanical | 6 | 0.2000 | 13.63579618 | 1 | 0.90198074 |
| system | | | | | |
| Power system | 5 | 0.1667 | 0.55340026 | 1 | 0.18170911 |
| Total | 30 | 1.0000 | 16.76046135 | — | — |

In Table 2, the complexity, the hazard degree, and the two importance degrees are indices that are assessed according to values and are unitless. They are assessed and determined according to values.

Reliability allocation results of the improved and traditional AGREE reliability allocation methods are as shown in Table 3.

TABLE 3
Subsystem Reliability Allocation Results

| | Traditional AGREE | | Improved AGREE | | | |
|---|---|---|---|---|---|---|
| | Allocation Method | | Allocation Method | | Predicted Data | |
| | Failure Rate/ | Reliability | Failure Rate/ | Reliability | Failure Rate/ | Reliability |
| Subsystem | (10⁻⁴ · h⁻¹) | Degree | (10⁻⁴ · h⁻¹) | Degree | (10⁻⁴ · h⁻¹) | Degree |
| Hydraulic | 0.4667 | 0.99995333 | 1.7356 | 0.99982644 | 0.1860 | 0.99998140 |
| system | | | | | | |
| Pneumatic | 0.3334 | 0.99996666 | 3.6260 | 0.99963740 | 0.0501 | 0.99999499 |
| system | | | | | | |
| Electronic | 0.4667 | 0.99995333 | 1.7314 | 0.99982686 | 0.2511 | 0.99997489 |
| control | | | | | | |
| system | | | | | | |
| Mechanical | 0.4000 | 0.99996000 | 0.4435 | 0.99995565 | 0.7725 | 0.99992275 |
| system | | | | | | |
| Power | 0.3334 | 0.99996666 | 1.8346 | 0.99981654 | 0.2271 | 0.99997729 |
| system | | | | | | |

In table 3, the reliability degree is an index that is assessed according to its value and is unitless. it is assessed and determined according to its value.

In combination with the hazard degree analysis of the ultra-deep water pile hammer system, the reliability allocation results of parts are obtained, as shown in Table 4.

TABLE 4
Reliability Allocation Results of Parts

| | Serial | | | | | Reliability |
|---|---|---|---|---|---|---|
| Subsystem | Number | Part | Cₚᵥ | ωⱼᵥ | Pⱼᵥ/(10⁻⁴ · h⁻¹) | Degree |
| Hydraulic | 1 | Electro-hydraulic | 0.481500089 | 0.397324572 | 0.0057 | 0.99999943 |
| system | | directional | | | | |
| | | control valve | | | | |
| | 2 | Other valve | 0.236231488 | 0.194933661 | 0.0116 | 0.99999884 |
| | | groups | | | | |
| | 3 | Hydraulic | 0.201032214 | 0.165887900 | 0.0136 | 0.99999864 |
| | | cylinder | | | | |
| | 4 | Hydraulic pump | 0.274127586 | 0.226204789 | 0.0100 | 0.99999900 |
| | 5 | Hydraulic oil | 0.002978400 | 0.002457718 | 0.9189 | 0.99990811 |
| | 6 | Oil tank | 0.010730027 | 0.008854211 | 0.2551 | 0.99997449 |
| | 7 | Accumulator | 0.005256000 | 0.004337150 | 0.5207 | 0.99994793 |
| Pneumatic | 8 | Air compressor | 0.077528475 | 0.547280069 | 0.0463 | 0.99999537 |
| system | 9 | Air filter | 0.004077639 | 0.028784399 | 0.8795 | 0.99991205 |
| | 10 | Atomized | 0.002340492 | 0.016521731 | 1.5323 | 0.99984677 |
| | | lubricator | | | | |
| | 11 | Oil pressure | 0.003253714 | 0.022968243 | 1.1022 | 0.99988978 |
| | | buffer | | | | |
| | 12 | Pneumatic valve | 0.054461106 | 0.384445558 | 0.0658 | 0.99999342 |
| | | groups | | | | |
| Electronic | 13 | Transformer | 0.754532522 | 0.619613190 | 0.0160 | 0.99999840 |
| control | 14 | Programmable | 0.116946000 | 0.096034673 | 0.1035 | 0.99998965 |
| system | | logic controller | | | | |
| | 15 | Ethernet switch | 0.100740000 | 0.082726498 | 0.1201 | 0.99998799 |
| | 16 | Breaker | 0.031536000 | 0.025896991 | 0.3837 | 0.99996163 |
| | 17 | Relay | 0.019146702 | 0.015723045 | 0.6320 | 0.99993680 |
| | 18 | Electromagnetic | 0.030044091 | 0.024671852 | 0.4027 | 0.99995973 |
| | | pilot operated | | | | |
| | | valve | | | | |
| | 19 | Various sensors | 0.164802360 | 0.135333750 | 0.0734 | 0.99999266 |
| Mechanical | 20 | Hammer head | 1.199456633 | 0.088258652 | 0.0115 | 0.99999885 |
| system | | (hammer core) | | | | |
| | 21 | Anvil | 1.035610776 | 0.076202514 | 0.0134 | 0.99999866 |
| | 22 | Steel pile | 10.737918915 | 0.790119645 | 0.0013 | 0.99999987 |
| | 23 | Pile cap | 0.166440000 | 0.012247021 | 0.0831 | 0.99999169 |
| | 24 | Hammer core | 0.450817858 | 0.033172168 | 0.0307 | 0.99999693 |
| | | hanging unit | | | | |
| | 25 | Shock absorbing | 0.045552000 | 0.076052806 | 0.3036 | 0.99996964 |
| | | ring | | | | |
| Power | 26 | Deep water | 0.109965513 | 0.183596458 | 0.2123 | 0.99997877 |
| system | | motor | | | | |
| | 27 | Pressure | 0.030222000 | 0.050458112 | 0.7724 | 0.99992276 |
| | | compensator | | | | |
| | 28 | Winch | 0.075435340 | 0.125945498 | 0.3094 | 0.99996906 |
| | 29 | Dynamic | 0.050840595 | 0.084882550 | 0.4591 | 0.99995409 |
| | | umbilical cable | | | | |
| | 30 | Generator set | 0.286936809 | 0.479064576 | 0.0814 | 0.99999186 |

In table 4, Cₚᵥ, ωⱼᵥ, and the reliability degree are indices that are assessed according to values and are unitless. They are assessed and determined according to values. The predicted failure rate values of the parts are as shown in Table 5.

TABLE 5
Predicted Failure Rate Value of Parts

| | Predicted | | Predicted | | Predicted |
|---|---|---|---|---|---|
| | Failure Rate | | Failure Rate | | Failure Rate |
| | Value/ | | Value/ | | Value/ |
| Part Name | (10⁻⁶ · h⁻¹) | Part Name | (10⁻⁶ · h⁻¹) | Part Name | (10⁻⁶ · h⁻¹) |
| Electro-hydraulic | 4.0600 | Oil pressure | 0.3500 | Anvil | 12.7400 |
| directional | | buffer | | | |
| control valve | | | | | |
| Other valve | 2.9300 | Pneumatic | 1.8800 | Steel pile | 15.3399 |
| groups | | valve groups | | | |
| Hydraulic | 3.6700 | Transformer | 9.0400 | Pile cap | 1.9000 |
| cylinder | | | | | |
| Hydraulic pump | 6.9600 | Programmable | 0.8900 | Hammer core | 16.1199 |
| | | logic controller | | hanging unit | |
| Hydraulic oil | 0.1700 | Ethernet switch | 1.1500 | Shock | 2.6000 |
| | | | | absorbing ring | |
| Oil tank | 0.4500 | Breaker | 1.2000 | Deep water | 3.9800 |
| | | | | motor | |
| Energy | 0.3600 | Relay | 3.2300 | Pressure | 1.1500 |
| accumulator | | | | compensator | |
| Air compressor | 1.7700 | Electromagnetic | 1.9400 | Winch | 1.9400 |
| | | pilot operated | | | |
| | | valve | | | |
| Air filter | 0.6200 | Various sensors | 7.6600 | Dynamic | 5.1600 |
| | | | | umbilical cable | |
| Atomized | 0.3900 | Hammer head | 28.5497 | Generator set | 10.4800 |
| lubricator | | (hammer core) | | | |

The reliability indices that the parts are allocated with in Table 4 are set as reliability design indices and compared with the predicted failure rate values of the parts in Table 5, and reliability allocation is performed on the basic failure modes of the parts. The allocation results are as shown in Table 6.

TABLE 6
Failure Mode Reliability Allocation Result Table

| Event | Failure Rate/ | Event | Failure Rate/ | Event | Failure Rate/ | Event | Failure Rate/ |
|---|---|---|---|---|---|---|---|
| Code | (10⁻⁶ · h⁻¹) | Code | (10⁻⁶ · h⁻¹) | Code | (10⁻⁶ · h⁻¹) | Code | (10⁻⁶ · h⁻¹) |
| X1 | 0.0042 | X11 | 0.0593 | X21 | — | X31 | — |
| X2 | 0.0814 | X12 | 0.4262 | X22 | — | X32 | — |
| X3 | 0.0042 | X13 | 0.0556 | X23 | — | X33 | — |
| X4 | 0.4633 | X14 | 0.0630 | X24 | — | X34 | — |
| X5 | 0.0168 | X15 | 0.3224 | X25 | — | X35 | — |
| X6 | 0.0792 | X16 | 0.4336 | X26 | — | X36 | — |
| X7 | 0.0554 | X17 | 0.1739 | X27 | — | X37 | — |
| X8 | 0.8987 | X18 | 0.1624 | X28 | — | X38 | — |
| X9 | 0.0396 | X19 | 0.2845 | X29 | — | X39 | — |
| X10 | 0.0871 | X20 | 0.3793 | X30 | — | X40 | — |
| X41 | — | X56 | 3.8712 | X71 | 0.0397 | X86 | — |
| X42 | — | X57 | 2.5680 | X72 | — | X87 | — |
| X43 | 0.0389 | X58 | 0.6708 | X73 | — | X88 | — |
| X44 | 0.7805 | X59 | 0.1150 | X74 | 1.0894 | X89 | — |
| X45 | 0.7805 | X60 | 0.2296 | X75 | 1.0894 | X90 | — |
| X46 | — | X61 | 0.2324 | X76 | 0.8913 | X91 | — |
| X47 | — | X62 | 0.2288 | X77 | — | X92 | — |
| X48 | — | X63 | 0.2288 | X78 | — | X93 | — |
| X49 | — | X64 | 0.2304 | X79 | — | X94 | 2.4777 |
| X50 | — | X65 | 0.6016 | X80 | — | X95 | 1.5146 |
| X51 | — | X66 | 0.1367 | X81 | — | X96 | 0.8777 |
| X52 | — | X67 | 0.6016 | X82 | — | X97 | 0.8777 |
| X53 | — | X68 | 0.0397 | X83 | — | X98 | 0.8777 |
| X54 | — | X69 | 0.0397 | X84 | — | X99 | 1.5146 |
| X55 | 0.1150 | X70 | 0.0110 | X85 | — | — | — |

The above embodiments are merely intended to describe the technical solutions of the present disclosure, rather than to limit the present disclosure. Although the present disclosure is described in detail with reference to the above embodiments, persons of ordinary skill in the art should understand that modifications may be made to the technical solutions described in the above embodiments or equivalent replacements may be made to some or all technical features thereof, which do not make the essence of corresponding technical solutions depart from the scope of the technical solutions in the embodiments of the present disclosure.

What is claimed is:

1. A reliability optimization method for an ultra-deep water pile hammer system, comprising:
S1, performing function analysis and functional module division on a mechanical system, a power system, a hydraulic system, a pneumatic system, and an electronic control system of the ultra-deep water pile hammer system, regarding the five systems as five first-level subsystems, and defining key parameters of the first-level subsystems;
wherein the key parameters of the first-level subsystems comprise design requirements of a complexity degree, an importance degree, and a reliability degree, a failure mode and a severity degree of influence on the ultra-deep water pile hammer system, and a series-parallel connection relationship between the first-level subsystems;
S2, further dividing the first-level subsystems into second-level subsystems, the second-level subsystems being parts or components constituting the first-level subsystems; and defining key parameters of the second-level subsystems;
wherein the key parameters of the second-level subsystems comprise design requirements of a complexity degree, an importance degree, and a reliability degree, a hazard degree under a certain severe degree, an occurrence probability and a hazard degree of a certain failure mode, and a series-parallel connection relationship between the second-level subsystems;
S3, performing hazard degree analysis on the second-level subsystems;
S4, establishing a first-level subsystem reliability allocation model to allocate first-level subsystem reliability indices of an ultra-deep water pile hammer;
S5, establishing a second-level subsystem reliability allocation model to allocate second-level subsystem reliability indices of the ultra-deep water pile hammer;
S6, establishing a second-level subsystem failure mode reliability allocation model to allocate second-level subsystem failure mode reliability indices of the ultra-deep water pile hammer; and
S7, obtaining an optimal reliability allocation solution of the ultra-deep water pile hammer system.

2. The reliability optimization method for an ultra-deep water pile hammer system according to claim 1, wherein S3 comprises performing hazard degree analysis on the second-level subsystems by an improved quantitative hazard analysis method, and a calculation formula for a hazard degree Cₚ of a part is as follows:
$${C}_{p} = {Σ}_{i = 1}^{k} {λ}_{p} {α}_{i} {β}_{i} {s}_{i} t ;$$
wherein Cₚ represents the hazard degree of the part; k represents a total number of failure modes of the part; λₚ represents an occurrence rate of an ith failure mode of the part; αᵢ represents a percentage of the occurrence rate of the ith failure mode of the part and a sum of occurrence rates of all the failure modes of the part; βᵢ represents a conditional probability of the ith failure mode of the part causing a system failure, 0≤βᵢ≤1; sᵢ represents a severe degree of the ith failure mode of the part; and t represents an average operation time of the part.

3. The reliability optimization method for an ultra-deep water pile hammer system according to claim 2, wherein S4 comprises using an improved Advisory Group on Reliability of Electronic Equipment (AGREE) reliability allocation method to allocate the first-level subsystem reliability indices of the ultra-deep water pile hammer:
$${( {W}_{j}^{*} )}^{2} = \frac{{Σ}_{v = 1}^{m} {Σ}_{i = 1}^{k} {λ}_{p} {α}_{i} {β}_{i} {s}_{i} t}{{Σ}_{v = 1}^{n} {Σ}_{i = 1}^{k} {λ}_{p} {α}_{i} {β}_{i} {s}_{i} t} = \frac{{Σ}_{v = 1}^{m} {C}_{pv}}{{Σ}_{v = 1}^{n} {C}_{pv}} = \frac{{θ}_{j}}{θ} ;$$
wherein
$${W}_{j}^{*}$$
represents a correction importance degree of a jth subsystem; m represents a number of parts of the jth subsystem; k represents a number of failure modes of a vth part; n represents a number of parts of the whole system; Cₚᵥ represents a hazard degree of the vth part; θⱼ represents a hazard degree of the jth subsystem; θ and represents a hazard degree of the whole system.

4. The reliability optimization method for an ultra-deep water pile hammer system according to claim 3, wherein S5 comprises using a reliability allocation method based on Failure Mode, Effects and Hazard degree Analysis (FMECA) to allocate the second-level subsystem reliability indices of the ultra-deep water pile hammer:
$$\{ \begin{matrix}{P}_{jv} = {P}_{j} \frac{1}{{ω}_{jv}} / {\sum }_{v = 1}^{m} \frac{1}{{ω}_{jv}} \\ {ω}_{j} = ( \frac{{C}_{p 1}}{{Σ}_{v = 1}^{m} {C}_{pv}} , … , \frac{{C}_{pv}}{{Σ}_{v = 1}^{m} {C}_{pv}} , … , \frac{{C}_{pm}}{{Σ}_{v = 1}^{m} {C}_{pv}} )\end{matrix} ;$$
wherein Pⱼᵥ represents a reliability index of the vth part of the jth subsystem; Pⱼ represents a specified reliability allocation index of the jth subsystem; ωⱼ represents a normalized weight of the parts of the jth subsystem relative to the subsystem; ωⱼᵥ represents a normalized weight of the vth part of the jth subsystem relative to the subsystem; and Cₚₘ represents a hazard degree of an mth part.

5. The reliability optimization method for an ultra-deep water pile hammer system according to claim 4, wherein S6 comprises using a predicted value based allocation method to perform reliability allocation on basic failure modes of a part; the basic failure modes of the part are all in a series connection relationship, and the reliability allocation is performed on the part only when a specified failure probability is lower than a predicted failure probability, with a reliability degree allocation formula being as follows:
$$\{ \begin{matrix}{q}_{ip} = {q}_{iy} \frac{{q}_{sq}}{{q}_{sy}} \\ {R}_{ip} = 1 - {q}_{ip}\end{matrix} i ∈ [ 1 , n ] ;$$
wherein qᵢₚ represents an unreliability allocation value of an ith failure mode; q_{iy} represents a predicted occurrence rate value of the ith failure mode; q_{sq} represents a specified failure rate value for the part; q_{sy} represents a predicted failure rate value for the part; Rip represents a reliability degree allocation value of the ith failure mode; and qᵢₚ represents an unreliability allocation value of an ith failure mode.

6. The reliability optimization method for an ultra-deep water pile hammer system according to claim 5, wherein S7 comprises comparing a second-level subsystem hazard degree analysis result, a first-level subsystem reliability index allocation result, a second-level subsystem reliability index allocation result, and a second-level subsystem failure mode reliability index allocation result, and selecting an optimal value, to form the optimal reliability allocation solution.
